(19) United States
(12) Patent Application Publication
(10) Pub. No.: US 2025/0360606 A1
(43) Pub. Date: Nov. 27, 2025

(54) RECIPROCATING TOOL, AND METHOD FOR CONTROLLING ELECTRIC MOTOR OF RECIPROCATING TOOL

(71) Applicant: MAKITA CORPORATION, Anjo-shi (JP)

(72) Inventor: Yuki KAWAI, Anjo-shi (JP)

(73) Assignee: MAKITA CORPORATION, Anjo-shi (JP)

(21) Appl. No.: 19/217,652

(22) Filed: May 23, 2025

(30) Foreign Application Priority Data
May 24, 2024 (JP) 2024-085136

(51) Int. Cl. B25C 5/15

(52) U.S. Cl. CPC B25C 5/15

(57) ABSTRACT

One aspect of the present disclosure provides a reciprocating tool including a reciprocating member, an electric motor, a transmission device, a control circuit, a drive circuit, a position detector, and a signal cutoff circuit. The drive circuit (i) receives at least one drive signal, and (ii) drives the electric motor in accordance with the at least one drive signal received. The position detector outputs a position detection signal each time the reciprocating member reaches a specified position in at least one reciprocating motion thereof. The signal cutoff circuit includes wired logic configured to cut off the drive circuit from the at least one drive signal in response to the position detector outputting or having output the position detection signal.

### CROSS-REFERENCE TO RELATED APPLICATIONS

The present application claims the benefit of Japanese Patent Application No. 2024-085136 filed on May 24, 2024 with the Japan Patent Office, the entire disclosure of which is incorporated herein by reference.

### BACKGROUND

The present disclosure relates to a reciprocating tool.

Japanese Unexamined Patent Application Publication No. 2019-098456 discloses a fastener driving tool including a control unit configured to stop an electric motor of the fastener driving tool when a striking unit of the fastener driving tool reaches a standby position. The control unit has a microprocessor.

### SUMMARY

In the above-described fastener driving tool, a stopping operation of the electric motor may be delayed if an operation of the microprocessor is delayed due to a processing load of the microprocessor.

In one aspect of the present disclosure, it is desirable to provide a technique for inhibiting delay in stopping operation of an electric motor in a reciprocating tool.

In the present disclosure, it should be noted that the terms such as “first” and “second” are intended simply to distinguish elements from each other, and are not intended to limit the order or the number of the elements. The first element may be referred to as the second element, and similarly, the second element may be referred to as the first element. In addition, the first element may be included without the second element, and similarly, the second element may be included without the first element.

One aspect of the present disclosure provides a reciprocating tool including a reciprocating member, an electric motor, a transmission device, a control circuit, a drive circuit, a position detector, and a signal cutoff circuit.

The reciprocating member is configured to reciprocate between first dead center and second dead center.

The electric motor is configured to generate a driving force.

The transmission device is configured to transmit the driving force of the electric motor to the reciprocating member at least in a stroke of the reciprocating member from the second dead center to the first dead center.

The control circuit is configured to output at least one drive signal for driving the electric motor.

The drive circuit is configured (i) to receive the at least one drive signal, and (ii) to drive the electric motor in accordance with the at least one drive signal received.

The position detector is configured to output a position detection signal each time the reciprocating member reaches a specified position in at least one reciprocating motion thereof.

The signal cutoff circuit includes wired logic configured to cut off the drive circuit from the at least one drive signal in response to the position detector outputting or having output the position detection signal.

With the reciprocating tool configured as above, when the reciprocating member reaches the specified position in the at least one reciprocating motion thereof, the wired logic cuts off the drive circuit from the at least one drive signal without delay that may occur due to a processing load in a microprocessor. Consequently, driving of the electric motor by the drive circuit can be immediately stopped.

Accordingly, in this reciprocating tool, it is possible to inhibit delay in stopping operation of the electric motor.

Another aspect of the present disclosure provides a method for controlling an electric motor of a reciprocating tool, the method including:
outputting, to a drive circuit of the reciprocating tool, at least one drive signal for driving the electric motor, the drive circuit being configured to drive the electric motor in accordance with the at least one drive signal;
transmitting a driving force of the electric motor to a reciprocating member of the reciprocating tool, the reciprocating member being configured to reciprocate between first dead center and second dead center, the driving force being transmitted at least from the second dead center to the first dead center; and
stopping driving of the electric motor by wired logic, the wired logic being configured to cut off the drive circuit from the at least one drive signal in response to the reciprocating member having reached a specified position in at least one reciprocating motion thereof.

With the method as above, it is possible to inhibit delay in stopping operation of the electric motor by the wired logic.

### BRIEF DESCRIPTION OF THE DRAWINGS

An example embodiment of the present disclosure will be described hereinafter with reference to the accompanying drawings, in which:

FIG. 1 is an external view of a reciprocating tool in an example embodiment;

FIG. 2 is a central longitudinal cross-sectional view of the reciprocating tool;

FIG. 3A is a cross-sectional view of the reciprocating tool taken by a line IIIA-IIIA in FIG. 1, and FIG. 3B is a top view of the reciprocating tool including a perspective view of a motor housing;

FIGS. 4A through 4D show one sequence of mechanical operations in the reciprocating tool;

FIGS. 5A through 5E show operations of a holder corresponding to the one sequence of mechanical operations in the reciprocating tool;

FIG. 6 is a circuit diagram showing an electrical configuration of the reciprocating tool;

FIG. 7A is a block diagram showing a configuration of a first latching circuit, and FIG. 7B is a timing diagram showing an operation of the first latching circuit;

FIG. 8 is a timing diagram showing an outline of an electrical operation of the reciprocating tool;

FIG. 9 is a flowchart showing a flow of a main routine executed by a control circuit;

FIG. 10 is a flowchart showing a flow of a motor control process executed by the control circuit;

FIGS. 11A through 11C are schematic diagrams related to a mechanical configuration of the reciprocating tool in a first variation;

FIG. 12 is a circuit diagram showing an electrical configuration of the reciprocating tool in the first variation; and

FIG. 13A is a block diagram showing a configuration of a third latching circuit, and FIG. 13B is a timing diagram showing an operation of the third latching circuit.

### DETAILED DESCRIPTION OF EXEMPLARY EMBODIMENTS

### 1. Overview of Embodiments

One embodiment may provide a reciprocating tool including at least any one of:
Feature 1: a reciprocating member configured to reciprocate between first dead center and second dead center;
Feature 2: an electric motor configured to generate a driving force;
Feature 3: a transmission device configured to transmit the driving force of the electric motor to the reciprocating member at least in a stroke of the reciprocating member from the second dead center to the first dead center;
Feature 4: a control circuit configured (or programmed) to output at least one drive signal for driving the electric motor;
Feature 5: a drive circuit configured (i) to receive the at least one drive signal, and (ii) to drive the electric motor in accordance with the at least one drive signal received;
Feature 6: a position detector configured to output a position detection signal each time the reciprocating member reaches a specified position (or a specified phase, or a specified phase angle) in at least one reciprocating motion thereof; and
Feature 7: a signal cutoff circuit including wired logic (or hardwired logic) configured to cut off the drive circuit from the at least one drive signal (or cut off the at least one drive signal to the drive circuit) in response to the position detector outputting or having output the position detection signal.

In the reciprocating tool including at least Features 1 through 7, when the reciprocating member reaches the specified position in the at least one reciprocating motion, the wired logic cuts off the drive circuit from the at least one drive signal without delay that may occur due to a processing load in a microprocessor. Consequently, driving of the electric motor by the drive circuit can be immediately stopped.

Accordingly, in this reciprocating tool, it is possible to inhibit delay in stopping operation of the electric motor.

Examples of the reciprocating tool include an electric nailer, an electric rebar tier, an electric rebar cutter, an electric lubricator, and an electric inflator. Examples of the electric lubricator include an electric grease gun.

Examples of the electric motor include a DC motor, an AC motor, and a stepper motor. Examples of the DC motor include a brushless DC motor, and a brushed DC motor.

Examples of the drive circuit include a full-bridge circuit and a half-bridge circuit.

In one embodiment, the control circuit may be integrated into a single electronic unit or a single electronic device or a single circuit board.

In one embodiment, the control circuit may be a combination of two or more electronic circuits or two or more electronic units or two or more electronic devices provided separately on or in the reciprocating tool.

In one embodiment, the control circuit may include a microcomputer (or a microcontroller or a microprocessor), wired logic, an application specific integrated circuit (ASIC), an application specific standard product (ASSP), a programmable logic device (PLD) (such as a field programmable gate array (FPGA)), a discrete electronic component, and/or any combination of the foregoing.

In one embodiment, the signal cutoff circuit may include a PLD.

One embodiment may include, in addition to or in place of at least any one of Features 1 through 7, at least any one of:
Feature 8: the signal cutoff circuit is configured (i) to be disabled upon receipt of a first logic value (or a first logic level), and (ii) to be enabled upon receipt of a second logic value (or a second logic level); and
Feature 9: the second logic value is opposite to the first logic value.

In the reciprocating tool including at least Features 1 through 9, the signal cutoff circuit can be enabled or disabled by the first logic value or the second logic value input to the signal cutoff circuit.

One embodiment may include, in addition to or in place of at least any one of Features 1 through 9, at least any one of:
Feature 10: a manual switch configured to be manually operated by a user of the reciprocating tool; and
Feature 11: a latching circuit configured to continue to output the second logic value to the signal cutoff circuit until the manual switch is manually operated in response to the position detector outputting or having output the position detection signal.

In the reciprocating tool including at least Features 1 through 11, the signal cutoff circuit can be manually disabled by the user.

In one embodiment, the latching circuit may include a PLD.

One embodiment may include, in addition to or in place of at least any one of Features 1 through 11, at least any one of:
Feature 12: a pressing member configured to be pressed against a workpiece by the user; and
Feature 13: the manual switch is configured to be manually operated by the pressing member being pressed against the workpiece.

In the reciprocating tool including at least Features 1 through 13, the user can disable the signal cutoff circuit by pressing the pressing member against the workpiece.

One embodiment may include, in addition to or in place of at least any one of Features 1 through 13:
Feature 14: the position detector includes (i) a magnet having a first magnetic pole and a second magnetic pole and (ii) a Hall element configured to detect the first magnetic pole of the magnet, and is configured such that the Hall element detects the first magnetic pole and outputs the position detection signal in response to the reciprocating member having reached the specified position.

The reciprocating tool including at least Features 1 through 7 and 14 has great durability, compared with if the reciprocating tool were configured to mechanically detect the position of the reciprocating member. Furthermore, the reciprocating tool as such is not susceptible to dust in position detection of the reciprocating member, compared with if the reciprocating tool were configured to optically detect the position of the reciprocating member.

One embodiment may include, in addition to or in place of at least any one of Features 1 through 14, at least any one of:
Feature 15: the transmission device includes a cam (i) including an outer circumference having two or more pins aligned in a circumferential direction of the cam, and (ii) configured to rotate by the driving force of the electric motor;
Feature 16: the transmission device includes a holder (i) holding the magnet, and (ii) configured to rotate with the cam; and
Feature 17: the reciprocating member (i) extends between the first dead center and the second dead center, (ii) includes two or more racks in its extending direction, and (iii) is configured to be driven from the second dead center to the first dead center by each of the two or more racks engaging with a corresponding one of the two or more pins.

In the reciprocating tool including at least Features 1 through 7 and 14 through 17, the reciprocating member can be moved at least from the second dead center to the first dead center by the cam. In addition, reaching of the reciprocating member to the specified position can be detected based on a rotational position of the holder that rotates with the cam.

One embodiment may include, in addition to or in place of at least any one of Features 1 through 17:
Feature 18: the first magnetic pole faces outward in a radial direction of the holder.

In the reciprocating tool including at least Features 1 through 7 and 14 through 18, the Hall element can be disposed outward from the holder in the radial direction. Consequently, the size of the reciprocating tool in a direction intersecting the radial direction of the holder can be reduced.

One embodiment may include, in addition to or in place of at least any one of Features 1 through 18, at least any one of:
Feature 19: the cam and the holder are configured to rotate around a common axis; and
Feature 20: the electric motor includes a rotor serving as the common axis.

One embodiment may include, in addition to or in place of at least any one of Features 1 through 20:
Feature 21: the holder is a non-magnetic member.

In the reciprocating tool including at least Features 1 through 7, 14 through 17 and 21, it can be easier for the Hall element to detect the first magnetic pole.

One embodiment may include, in addition to or in place of at least any one of Features 1 through 21:
Feature 22: the at least one drive signal is at least one pulse-width modulated signal.

One embodiment may include, in addition to or in place of at least any one of Features 1 through 22, at least any one of:
Feature 23: the electric motor is a brushless DC motor including first through third coils;
Feature 24: the drive circuit includes first through sixth semiconductor switches that (i) form at least a part of a full-bridge circuit and (ii) are coupled to the first through third coils;
Feature 25: the first through third semiconductor switches are high-side switches in the full-bridge circuit;
Feature 26: the fourth through sixth semiconductor switches are low-side switches in the full-bridge circuit;
Feature 27: the at least one pulse-width modulated signal includes first through third pulse-width modulated signals respectively corresponding to the first through third semiconductor switches; and
Feature 28: the wired logic is configured to cut off the drive circuit from the first through third pulse-width modulated signals (or cut off the first through third pulse-width modulated signals to the drive circuit) in response to the position detector outputting or having output the position detection signal.

Examples of the brushless DC motor include a three-phase brushless DC motor, and a four-phase or more brushless DC motor.

Examples of the full-bridge circuit include a three-phase full-bridge circuit, and a four-phase or more full-bridge circuit.

One embodiment may include, in addition to or in place of at least any one of Features 1 through 28, at least any one of:
Feature 29: the control circuit is configured (or programmed) to output, to the drive circuit, fourth through sixth pulse-width modulated signals to brake the electric motor in response to the position detector outputting or having output the position detection signal; and
Feature 30: the fourth through sixth pulse-width modulated signals respectively correspond to the fourth through sixth semiconductor switches.

In the reciprocating tool including at least Features 1 through 7 and 22 through 30, the electric motor can be immediately stopped in response to the reciprocating member having reached the specified position.

One embodiment may include, in addition to or in place of at least any one of Features 1 through 30:
Feature 31: the control circuit includes a microcomputer configured (or programmed) to output the first through sixth pulse-width modulated signals.

One embodiment may include, in addition to or in place of at least any one of Features 1 through 31:
Feature 32: the specified position corresponds to (i) a stop position to stop the reciprocating member, and/or (ii) a standby position where the reciprocating member waits for at least one next reciprocating motion of the reciprocating member.

In the reciprocating tool including at least Features 1 through 7 and 32, the reciprocating member can be stopped at the stop position and/or the standby position.

One embodiment may include, in addition to or in place of at least any one of Features 1 through 32, at least any one of:
Feature 33: a cylinder (or a chamber) containing compressed gas therein;
Feature 34: a piston that (i) is inside the cylinder, and (ii) urges the reciprocating member toward the second dead center by the compressed gas; and
Feature 35: the reciprocating member is configured to be driven from the first dead center to the second dead center by the piston.

In the reciprocating tool including at least Features 1 through 7 and 33 through 35, the reciprocating member can be moved from the first dead center to the second dead center by a pressure applied from the compressed gas to the piston.

Examples of the compressed gas include compressed air, and compressed inert gas. The compressed air may be compressed dry air. Examples of the compressed inert gas include compressed nitrogen gas and compressed noble gas.

One embodiment may include, in addition to or in place of at least any one of Features 1 through 35:
Feature 36: the reciprocating member is configured (i) to be positioned at the first dead center in response to the piston being positioned at its top dead center, and (ii) to be positioned at the second dead center in response to the piston being positioned at its bottom dead center.

In the reciprocating tool including at least Features 1 through 7, and 33 through 36, the maximum pressure of the compressed gas is applied to the reciprocating member, and the reciprocating member can be moved from the first dead center to the second dead center. In addition, the reciprocating member moving from the second dead center to the first dead center can be decelerated by the pressure of the compressed gas.

One embodiment may provide a method including at least any one of:
Feature 37: outputting, to a drive circuit of a reciprocating tool, at least one drive signal for driving an electric motor of the reciprocating tool;
Feature 38: the drive circuit is configured to drive the electric motor in accordance with the at least one drive signal;
Feature 39: transmitting a driving force of the electric motor to a reciprocating member of the reciprocating tool;
Feature 40: the reciprocating member is configured to reciprocate between first dead center and second dead center;
Feature 41: the driving force is transmitted at least from the second dead center to the first dead center;
Feature 42: stopping driving of the electric motor by wired logic; and
Feature 43: the wired logic is configured to cut off the drive circuit from the at least one drive signal (or cut off the at least one drive signal to the drive circuit) in response to the reciprocating member having reached a specified position (or a specified phase, or a specified phase angle) in at least one reciprocating motion thereof.

According to the method including at least Features 37 through 43, it is possible to inhibit delay in stopping operation of the electric motor by the wired logic.

In one embodiment, Features 1 through 43 may be combined in any combination.

In one embodiment, any of Features 1 through 43 may be excluded.

### 2. Specific Example Embodiment

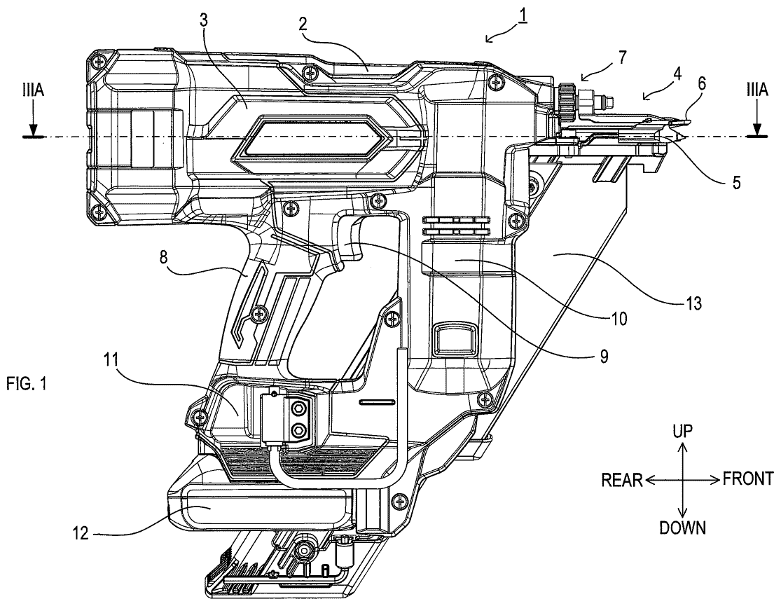

A specific example embodiment will be described below. This specific example embodiment provides a reciprocating tool 1 shown in FIG. 1.

The terms “up,” “down,” “front,” “rear,” “left,” and “right” in the following description or the drawings are used only to facilitate easy understanding of the structure of the reciprocating tool 1 and are not intended to limit the orientation of the reciprocating tool 1. The reciprocating tool 1 can be oriented in any direction.

### 2-1. Overall Structure of Reciprocating Tool

As shown in FIG. 1, the reciprocating tool 1 in the present embodiment is an electric nailer configured to drive a nail into a workpiece. Examples of the nail used in the reciprocating tool 1 include a staple, a pin nail, a finish nail, and a brad nail. In another embodiment, the reciprocating tool 1 may be any other type of reciprocating tool, such as an electric rebar tier, an electric rebar cutter, an electric lubricator, and an electric inflator.

The reciprocating tool 1 includes a housing 2. The housing 2 includes a driving assembly housing 3 extending from a rear end to a front end of the housing 2 (in other words, in a direction in which a nail is ejected). The reciprocating tool 1 includes an ejector 4 in front of the driving assembly housing 3. The ejector 4 includes a guide 5 configured to guide a nail ejected from the reciprocating tool 1 to a workpiece. In the present embodiment, the guide 5 protrudes from inside the driving assembly housing 3 to the front of the reciprocating tool 1. The ejector 4 includes a pressing member (or a contact) 6 configured to be pressed against a workpiece. The pressing member 6 is disposed above the guide 5, and protrudes most forward in the reciprocating tool 1. The ejector 4 includes a link mechanism 7 coupled to the pressing member 6.

The housing 2 includes a grip 8 extending downward from approximately a center of the driving assembly housing 3. The grip 8 is configured to be held in one hand of a user of the reciprocating tool 1. The grip 8 includes a trigger 9 on its upper front side. The trigger 9 is configured to be pulled by the user's finger (for example, index finger).

The housing 2 includes a motor housing 10 extending downward from a front part of the driving assembly housing 3. The housing 2 includes a battery attachment portion 11 extending from a lower end of the motor housing 10 to a lower end of the grip 8. The battery attachment portion 11 is configured to detachably attach a battery pack 12 to the battery attachment portion 11.

The reciprocating tool 1 includes a magazine 13 extending from a lower part of the guide 5 to a lowest end of the reciprocating tool 1 on a left side of the housing 2. The magazine 13 is configured to deliver one or more nails contained therein into the guide 5 one by one. In the present embodiment, the magazine 13 extends diagonally rearward.

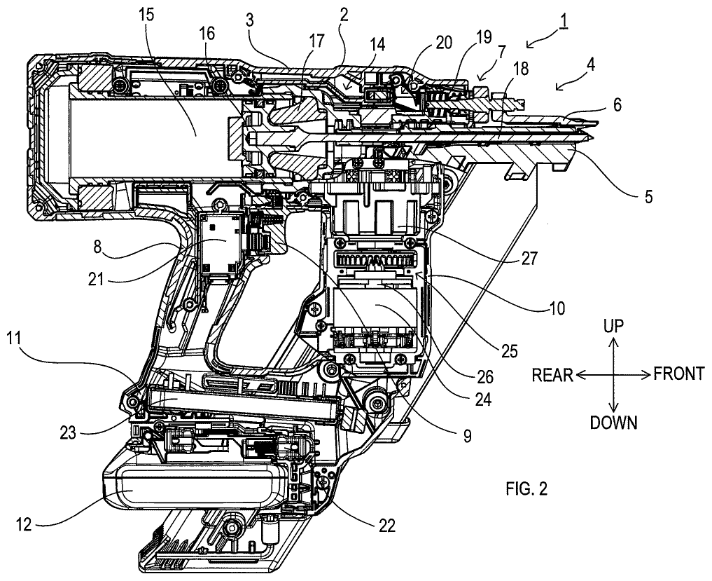

As shown in FIG. 2, the driving assembly housing 3 accommodates a driving assembly 14 configured to drive a nail.

The driving assembly 14 includes a cylinder 15 extending from a rear end of the driving assembly housing 3 to approximately the center thereof. The cylinder 15 contains compressed gas therein. In the present embodiment, the compressed gas is compressed dry air. In another embodiment, the compressed gas may be compressed inert gas, such as compressed nitrogen gas and compressed noble gas.

The cylinder 15 includes a piston 16 therein. The piston 16 is configured to move between rear and front ends of the cylinder 15 while sealing the cylinder 15. The driving assembly 14 includes a bumper 17 at the front end of the cylinder 15. The bumper 17 is configured to receive and stop the piston 16 when the piston 16 reaches the front end of the cylinder 15.

The driving assembly 14 includes a reciprocating member (or a driver) 18 passing through the bumper 17 and coupled to the piston 16. The reciprocating member 18 extends from the piston 16 toward a tip end of the guide 5. The reciprocating member 18 is configured to move toward the tip end of the guide 5 by a pressure applied to the piston 16 from the compressed gas. In other words, the piston 16 urges the reciprocating member 18 toward the tip end of the guide 5 by the compressed gas. In the present embodiment, the reciprocating member 18 has a length such that (i) a tip end of the reciprocating member 18 reaches the tip end of the guide 5 when the piston 16 reaches the front end of the cylinder 15 (in other words, bottom dead center of the piston 16), and (ii) the tip end of the reciprocating member 18 retreats (or retracts) into the driving assembly housing 3 when the piston 16 reaches the rear end of the cylinder 15 (in other words, top dead center of the piston 16).

The link mechanism 7 of the ejector 4 includes a spring 19 inside the driving assembly housing 3. The link mechanism 7 is configured to move the pressing member 6 rearward of the reciprocating tool 1 in response to a tip end of the pressing member 6 being pressed against a workpiece, while urging the pressing member 6 forward by the spring 19.

The driving assembly housing 3 accommodates a contact switch 20 above the reciprocating member 18. The contact switch 20 is configured to be pressed (in other words, turned ON) by the link mechanism 7 when the pressing member 6 is pressed against a workpiece.

The grip 8 accommodates a trigger switch 21. The trigger switch 21 is configured to be pressed (in other words, turned ON) when the trigger 9 is pulled. The trigger switch 21 is configured to be turned OFF when the user's finger is released from the trigger 9.

The battery attachment portion 11 accommodates a connector 22 configured to be detachably coupled to the battery pack 12 attached to the battery attachment portion 11. The battery attachment portion 11 accommodates a controller 23 above the connector 22.

The motor housing 10 accommodates an electric motor 24 in its lower part. In the present embodiment, the electric motor 24 is a three-phase brushless DC motor. In another embodiment, the electric motor 24 may be a single-phase brushless DC motor, a two-phase brushless DC motor, a four-phase or more brushless DC motor, a brushed DC motor, an AC motor, or a stepper motor.

The motor housing 10 accommodates a transmission device 25 above the electric motor 24. The transmission device 25 is coupled to a rotor 26 of the electric motor 24, and is configured to transmit a driving force of the electric motor 24 to the reciprocating member 18.

More specifically, the transmission device 25 includes a reducer 27 (i) having a preset deceleration ratio, and (ii) configured to convert the driving force of the electric motor 24 into a decelerated output and transmit the decelerated output to the reciprocating member 18. Accordingly, the transmission device 25 can transmit, to the reciprocating member 18, a torque proportional to the deceleration ratio of the reducer 27. In the present embodiment, the reducer 27 is a concentric gear reducer, more specifically, a planetary gear reducer. In another embodiment, the reducer 27 may be a parallel gear reducer or an orthogonal gear reducer, depending on the structure of the transmission device 25.

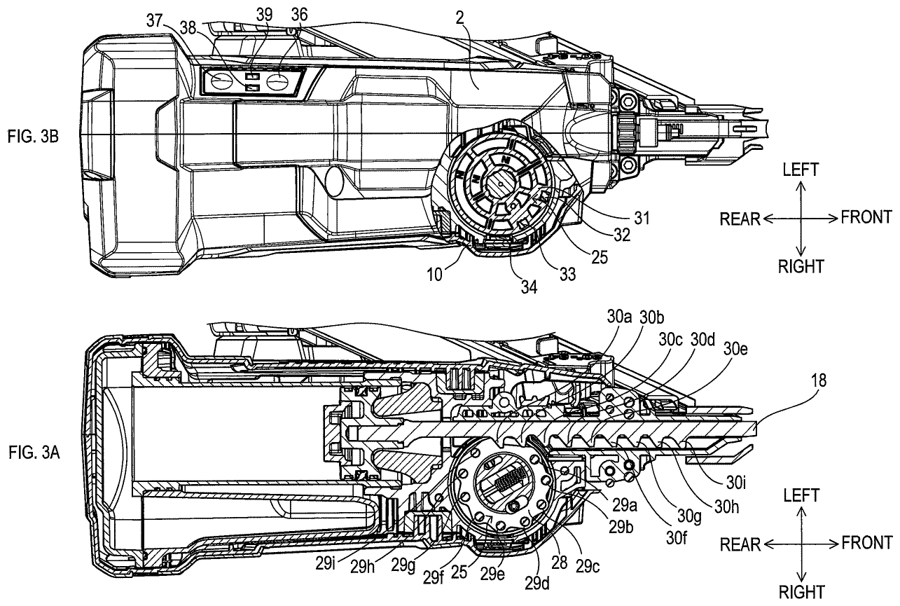

As shown in FIG. 3A, the transmission device 25 includes a cam 28 above the reducer 27. In the present embodiment, the cam 28 is disc-shaped. The cam 28 includes first through ninth pins 29a through 29i on its outer circumferential edge along its circumferential direction. The cam 28 is configured to rotate by receiving the output of the reducer 27. More specifically, the cam 28 rotates counterclockwise around the rotor 26 of the electric motor 24 when viewed from above the reciprocating tool 1.

The reciprocating member 18 includes first through ninth racks 30a through 30i on its right side. The first through ninth racks 30a through 30i are aligned in an extending direction of the reciprocating member 18. The first through ninth racks 30a through 30i correspond to the first through ninth pins 29a through 29i, respectively. The first through ninth pins 29a through 29i engage with the first through ninth racks 30a through 30i, respectively, to thereby transmit the driving force of the electric motor 24 to the reciprocating member 18.

As shown in FIG. 3B, the transmission device 25 includes a holder 31 above the cam 28. In the present embodiment, the holder 31 is disc-shaped. The holder 31 is a non-magnetic member. The holder 31 includes a first magnet 32 on its top surface. In the present embodiment, the first magnet 32 is disposed on the top surface of the holder 31 such that its south pole faces outward in a radial direction of the holder 31. In another embodiment, the first magnet 32 may be disposed on the top surface of the holder 31 such that its north pole faces outward in the radial direction of the holder 31.

The holder 31 includes a second magnet 33 on its top surface. In the present embodiment, the second magnet 33 is disposed on the top surface of the holder 31 such that its north pole faces outward in the radial direction of the holder 31. In another embodiment, the second magnet 33 may be disposed on the top surface of the holder 31 such that its south pole faces outward in the radial direction of the holder 31.

The holder 31 is configured to rotate by receiving the output of the reducer 27. More specifically, the holder 31, together with the cam 28, rotates counterclockwise around the rotor 26 of the electric motor 24 when viewed from above the reciprocating tool 1.

The motor housing 10 includes a Hall effect IC 34 on its right inner wall. The Hall effect IC 34 faces an outer circumferential edge of the holder 31. The Hall effect IC 34 is configured (i) to detect the south pole of the first magnet 32 when the first magnet 32 comes close to the Hall effect IC 34, and (ii) to detect the north pole of the second magnet 33 when the second magnet 33 comes close to the Hall effect IC 34.

The housing 2 includes, on a left side of its upper rear part, a main power switch 36 configured to be pressed by the user to turn the power of the reciprocating tool 1 ON or OFF.

The housing 2 includes a mode selection switch 37 adjacent to the main power switch 36. The mode selection switch 37 is configured to be pressed by the user to select operation modes of the reciprocating tool 1.

The housing 2 includes a first indicator 38 between the main power switch 36 and the mode selection switch 37. The first indicator 38 is turned ON (i) when the reciprocating tool 1 is set to a later-described single shot mode, or (ii) when malfunction occurs in the reciprocating tool 1.

The housing 2 includes a second indicator 39 adjacent to the first indicator 38. The second indicator 39 is turned ON (i) when the reciprocating tool 1 is set to a later-described multiple shot mode, or (ii) when malfunction occurs in the reciprocating tool 1.

### 2-2. Mechanical Operation of Reciprocating Tool

### 2-2-1. Mechanical Operations of Reciprocating Member and Cam

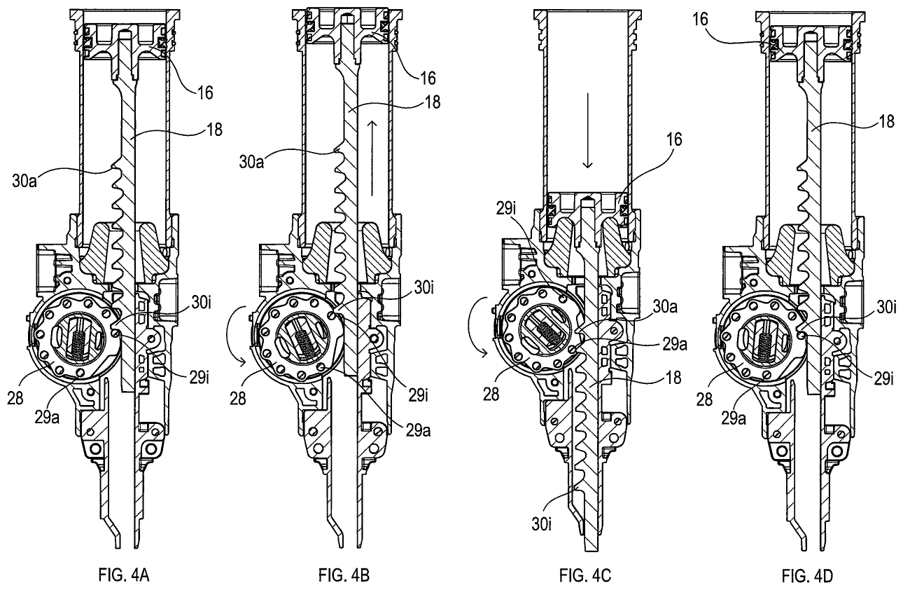

Referring to FIGS. 4A through 4D, operations of the reciprocating member 18 and the cam 28 will be described. In many cases, the user uses the reciprocating tool 1 with a front end of the reciprocating tool 1 facing downward, when machining a workpiece. Thus, in FIGS. 4A through 4D, the front end of the reciprocating tool 1 faces downward.

As shown in FIG. 4A, the reciprocating member 18 is normally held in a standby position. The standby position is set immediately before top dead center of the reciprocating member 18. In the present embodiment, the standby position is a position to stop the reciprocating member 18 as well as a position where the reciprocating member 18 waits for the next reciprocating motion of the reciprocating member 18. In the standby position, the first through eighth pins 29a through 29h of the cam 28 are disengaged from the first through eighth racks 30a through 30h of the reciprocating member 18, and only the ninth pin 29i of the cam 28 is engaged with the ninth rack 30i of the reciprocating member 18. At this point in time, the piston 16 is located immediately before its top dead center.

When the electric motor 24 is driven and the cam 28 rotates counterclockwise, the reciprocating member 18 is driven from the standby position to its top dead center, as shown in FIG. 4B. At this point in time, the piston 16 also reaches its top dead center.

When the reciprocating member 18 reaches its top dead center and the ninth pin 29i is disengaged from the ninth rack 30i, the reciprocating member 18 is driven to its bottom dead center by the pressure of the compressed gas applied from the piston 16, as shown in FIG. 4C. Consequently, a nail delivered into the guide 5 is struck by the reciprocating member 18 and driven into a workpiece. When the reciprocating member 18 reaches its bottom dead center, the piston 16 also reaches its bottom dead center. The cam 28 continues to rotate after the ninth pin 29i is disengaged from the ninth rack 30i, and the first through ninth pins 29a through 29i again engage with the first through ninth racks 30a through 30i, respectively. Then, as shown in FIG. 4D, the reciprocating member 18 returns to the standby position, and the cam 28 is stopped.

### 2-2-2. Mechanical Operation of Holder

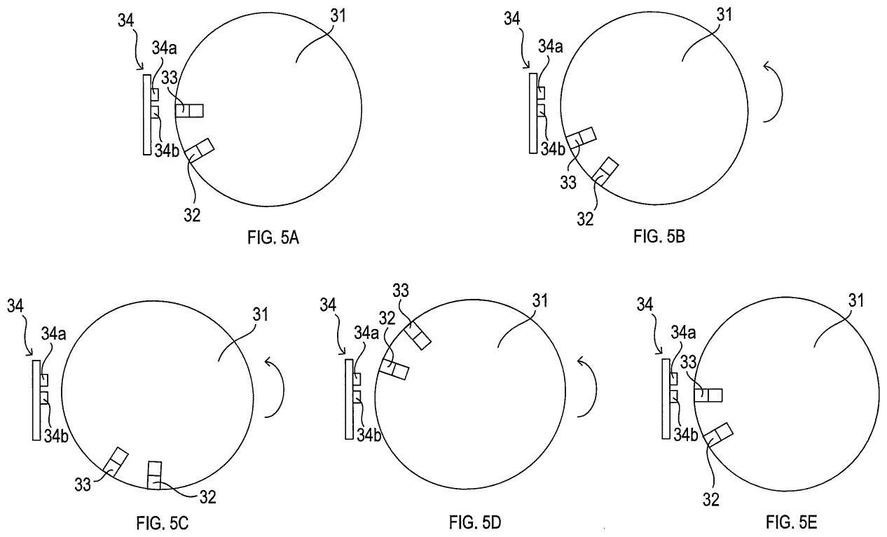

When the electric motor 24 is driven, the holder 31, together with the cam 28, rotates as shown in FIGS. 5A through 5E. FIGS. 5A through 5C and 5E respectively correspond to FIGS. 4A through 4D. FIG. 5D shows a rotational position of the holder 31 when the cam 28 is positioned between (i) the rotational position of the cam 28 shown in FIG. 4C, and (ii) the rotational position of the cam 28 shown in FIG. 4D.

The Hall effect IC 34 includes a first Hall element 34a. In the present embodiment, the first Hall element 34a is configured to detect the south pole of the first magnet 32. In another embodiment, when the first magnet 32 is disposed on the top surface of the holder 31 such that its north pole faces outward in the radial direction of the holder 31, the first Hall element 34a may be configured to detect the north pole of the first magnet 32.

The Hall effect IC 34 includes a second Hall element 34b. In the present embodiment, the second Hall element 34b is configured to detect the north pole of the second magnet 33. In another embodiment, when the second magnet 33 is disposed on the top surface of the holder 31 such that its south pole faces outward in the radial direction of the holder 31, the second Hall element 34b may be configured to detect the south pole of the second magnet 33.

The first magnet 32 is disposed before the second magnet 33 in the rotational direction of the holder 31 (i.e., the counterclockwise direction in FIGS. 5A through 5E).

More specifically, as shown in FIG. 5D, the first magnet 32 is disposed on the top surface of the holder 31 such that its south pole faces the first Hall element 34a at the timing to start preparing to stop the cam 28.

As shown in FIGS. 5A and 5E, the second magnet 33 is disposed on the top surface of the holder 31 such that its north pole faces the second Hall element 34b when the reciprocating member 18 is in the standby position.

### 2-3. Electrical Configuration of Reciprocating Tool

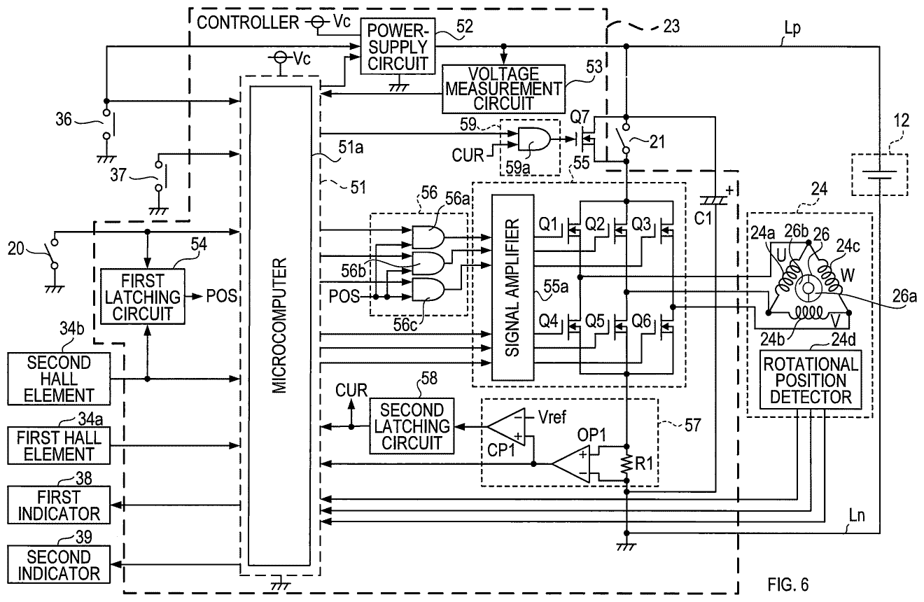

As shown in FIG. 6, the electric motor 24 includes first through third coils 24a through 24c respectively associated with three phases (that is, U-PHASE, V-PHASE, and W-PHASE) of the electric motor 24. The first through third coils 24a through 24c are configured to be sequentially excited so as to generate a rotating magnetic field. In the present embodiment, the first through third coils 24a through 24c form a delta connection. In another embodiment, the first through third coils 24a through 24c may form a star connection (or a wye connection). The rotor 26 (i) includes a first pole 26a and a second pole 26b, and (ii) is configured to rotate when the first pole 26a and the second pole 26b are subjected to the rotating magnetic field generated by the first through third coils 24a through 24c.

The electric motor 24 includes a rotational position detector 24d. The rotational position detector 24d is configured to output first through third pulse signals (or square wave signals) to the controller 23 in accordance with a rotational position of the rotor 26. In the present embodiment, the rotational position detector 24d is a Hall effect sensor. In the present embodiment, each of the first through third pulse signals reverses from positive (or HIGH) to negative (or LOW) or from negative (or LOW) to positive (or HIGH) each time the rotor 26 rotates by 180 electrical degrees. The first through third pulse signals have a phase difference of 60 electrical degrees from each other. In another embodiment, the rotational position detector 24d may be configured to output one pulse signal, instead of the first through third pulse signals, to the controller 23 each time the rotor 26 rotates by 60 electrical degrees. In yet another embodiment, the rotational position detector 24d may be configured to output first through third sine wave signals, instead of the first through third pulse signals, to the controller 23. In this case, the controller 23 may include a waveform conversion circuit configured to convert the first through third sine wave signals into first through third pulse signals. In yet another embodiment, the rotational position detector 24d may be a pulse encoder.

The reciprocating tool 1 includes a power line Lp extending from a positive electrode of the battery pack 12 attached to the battery attachment portion 11 to the controller 23. The reciprocating tool 1 includes a ground line Ln extending from a negative electrode of the battery pack 12 attached to the battery attachment portion 11 to the controller 23. The ground line Ln is coupled to a ground of the reciprocating tool 1 on the controller 23. The battery pack 12 applies its output voltage (hereinafter, referred to as “battery voltage”) between the power line Lp and the ground line Ln.

The controller 23 includes a control circuit 51. In the present embodiment, the control circuit 51 includes a microcomputer 51a. The microcomputer 51a includes a CPU (not shown), a ROM (not shown), a RAM (not shown), an analog-to-digital (A-to-D) converter (not shown), input ports (not shown), and output ports (not shown). In another embodiment, the control circuit 51 may include an additional microcomputer. In yet another embodiment, the control circuit 51 may include a logic circuit (or a wired logic connection) including two or more electronic components, in addition to or in place of the microcomputer 51a. In yet another embodiment, the control circuit 51 may include an ASIC and/or an ASSP, in addition to or in place of the microcomputer 51a. In yet another embodiment, the control circuit 51 may include a PLD on which a reconfigurable logic circuit can be implemented, in addition to or in place of the microcomputer 51a. Examples of the PLD include an FPGA.

The control circuit 51 is coupled to the rotational position detector 24d. The control circuit 51 is configured (i) to receive the first through third pulse signals from the rotational position detector 24d, and (ii) to detect the rotational position of the rotor 26 based on the first through third pulse signals received.

The control circuit 51 is coupled to the main power switch 36. The main power switch 36 includes (i) a first contact coupled to the ground of the reciprocating tool 1 and (ii) a second contact coupled to the control circuit 51. Accordingly, the main power switch 36 is configured to output a first negative logic signal to the control circuit 51 in response to the main power switch 36 being pressed (in other words, turned ON). The control circuit 51 is configured to detect that the main power switch 36 is ON based on the control circuit 51 receiving the first negative logic signal from the main power switch 36.

The control circuit 51 is coupled to the mode selection switch 37. The mode selection switch 37 includes (i) a first contact coupled to the ground of the reciprocating tool 1 and (ii) a second contact coupled to the control circuit 51. Accordingly, the mode selection switch 37 is configured to output a second negative logic signal to the control circuit 51 in response to the mode selection switch 37 being pressed (in other words, turned ON). The control circuit 51 is configured to detect that the mode selection switch 37 is ON based on the control circuit 51 receiving the second negative logic signal from the mode selection switch 37.

The control circuit 51 is coupled to the contact switch 20. The contact switch 20 includes (i) a first contact coupled to the ground of the reciprocating tool 1 and (ii) a second contact coupled to the control circuit 51. Accordingly, the contact switch 20 is configured to output a third negative logic signal to the control circuit 51 in response to the contact switch 20 being pressed (in other words, turned ON) by the pressing member 6 being pressed against a workpiece. The control circuit 51 is configured to detect that the contact switch 20 is ON based on the control circuit 51 receiving the third negative logic signal from the contact switch 20.

The control circuit 51 is coupled to the first Hall element 34a. The first Hall element 34a is configured to output a first position detection signal to the control circuit 51 in response to the first Hall element 34a detecting the south pole of the first magnet 32. In the present embodiment, the first position detection signal is a negative logic signal. In another embodiment, the first position detection signal may be a positive logic signal.

The control circuit 51 is coupled to the second Hall element 34b. The second Hall element 34b is configured to output a second position detection signal to the control circuit 51 in response to the second Hall element 34b detecting the north pole of the second magnet 33. In the present embodiment, the second position detection signal is a negative logic signal. In another embodiment, the second position detection signal may be a positive logic signal.

The control circuit 51 is (i) coupled to the first indicator 38, and (ii) configured to output a first lighting signal to the first indicator 38. The first indicator 38 is configured to be turned ON when receiving the first lighting signal from the control circuit 51.

The control circuit 51 is (i) coupled to the second indicator 39, and (ii) configured to output a second lighting signal to the second indicator 39. The second indicator 39 is configured to be turned ON when receiving the second lighting signal from the control circuit 51.

The controller 23 includes a power-supply circuit 52 coupled to (i) the first contact of the main power switch 36, (ii) the control circuit 51, (iii) the power line Lp, and (iv) the ground. The main power switch 36 is configured to output the first negative logic signal to the power-supply circuit 52, in addition to the control circuit 51. The control circuit 51 is configured to output a remote control (RC) signal to the power-supply circuit 52. In the present embodiment, the RC signal is a negative logic signal. In another embodiment, the RC signal may be a positive logic signal.

The power-supply circuit 52 is configured to maintain its ON-state (i) while receiving the first negative logic signal from the main power switch 36, or (ii) while receiving the RC signal from the control circuit 51. The power-supply circuit 52 is configured to generate, in its ON-state, a fixed direct voltage (hereinafter, referred to as “power-supply voltage”) Vc based on the battery voltage. The power-supply voltage Vc generated by the power-supply circuit 52 is delivered to the rotational position detector 24d, the first Hall element 34a, the second Hall element 34b, the first indicator 38, the second indicator 39, and various circuits on the controller 23, via not shown paths.

The controller 23 includes a voltage measurement circuit 53 configured (i) to measure the battery voltage on the power line Lp, and (ii) to output a battery voltage signal to the control circuit 51. The battery voltage signal is an analog signal having a voltage corresponding to the measured battery voltage.

The controller 23 includes a first latching circuit 54 coupled to (i) the first contact of the contact switch 20 and (ii) the second Hall element 34b. The first latching circuit 54 is configured (i) to hold its output (POS) negative (or LOW) in response to a falling edge (or a negative edge) of the second position detection signal output from the second Hall element 34b, and (ii) to reset its output to positive (or HIGH) in response to the third negative logic signal output from the contact switch 20.

The controller 23 includes a drive circuit 55 coupled to the control circuit 51. The control circuit 51 is configured to output first through sixth pulse-width modulated (PWM) signals to the drive circuit 55. The first through sixth PWM signals share the same cycle. The drive circuit 55 is configured to drive the electric motor 24 in accordance with the first through sixth PWM signals received from the control circuit 51.

More specifically, the drive circuit 55 includes a signal amplifier (or a level shifter) 55a configured to amplify the first through sixth PWM signals received from the control circuit 51.

The drive circuit 55 includes first through sixth switches Q1 through Q6 that form a three-phase full-bridge circuit. The first through third switches Q1 through Q3 are coupled to (i) the power line Lp and (ii) the first through third coils 24a through 24c so as to serve as high-side switches of the three-phase full-bridge circuit. The fourth through sixth switches Q4 through Q6 are coupled to (i) the first through third coils 24a through 24c and (ii) the ground so as to serve as low-side switches of the three-phase full-bridge circuit.

The first through sixth switches Q1 through Q6 are configured to respectively receive the first through sixth PWM signals amplified by the signal amplifier 55a, and to transition into their respective ON-states or OFF-states. In the present embodiment, the first through sixth switches Q1 through Q6 are n-channel metal-oxide semiconductor field-effect transistors (MOSFETs). In another embodiment, at least one of the first through sixth switches Q1 through Q6 may be other types of semiconductor switches including a junction field-effect transistor (JFET), a bipolar transistor, and an insulated gate bipolar transistor (IGBT). In yet another embodiment, each or at least one of the first through sixth switches Q1 through Q6 may be a mechanical relay.

The controller 23 includes a first signal cutoff circuit 56 configured to cut off the first through third PWM signals output from the control circuit 51. More specifically, the first signal cutoff circuit 56 is configured (i) to be disabled while the output (POS) of the first latching circuit 54 is positive, and (ii) to be enabled while the output of the first latching circuit 54 is negative. When the first signal cutoff circuit 56 is disabled, the first through third PWM signals are delivered to the drive circuit 55 via the first signal cutoff circuit 56. When the first signal cutoff circuit 56 is enabled, the first through third PWM signals are cut off from the drive circuit 55 by the first signal cutoff circuit 56.

In the present embodiment, the first signal cutoff circuit 56 includes wired logic. More specifically, the first signal cutoff circuit 56 includes first through third AND gates 56a through 56c. The first through third AND gates 56a through 56c are configured (i) to deliver the first through third PWM signals to the drive circuit 55 while the output of the first latching circuit 54 is positive, and (ii) to cut off the drive circuit 55 from the first through third PWM signals (or to cut off the first through third PWM signals to the drive circuit 55) by setting their respective outputs to negative (or LOW) while the output of the first latching circuit 54 is negative.

The controller 23 includes a current measurement circuit 57 (i) intercoupling (or interconnecting) between the drive circuit 55 and the ground, and (ii) configured to measure a magnitude of an electric current flowing through the electric motor 24 (hereinafter, referred to as “motor current”). The current measurement circuit 57 includes a shunt resistor R1. The shunt resistor R1 includes (i) a first end coupled to the fourth through sixth switches Q4 through Q6 and (ii) a second end coupled to the ground.

The current measurement circuit 57 includes a differential amplifier OP1 configured (i) to measure the magnitude of the motor current flowing through the shunt resistor R1, and (ii) to output a current measurement signal. More specifically, the differential amplifier OP1 is configured to amplify a voltage across the shunt resistor R1 to thereby generate the current measurement signal. Accordingly, the current measurement signal is an analog signal having a voltage corresponding to the magnitude of the motor current. The differential amplifier OP1 may be an open-loop configuration with no negative feedback circuit from its output to its input, or may be a closed-loop configuration with such a negative feedback circuit. The control circuit 51 is configured to receive the current measurement signal.

The current measurement circuit 57 includes a comparator CP1 configured to detect that the trigger switch 21 is ON. More specifically, the comparator CP1 is configured (i) to compare the voltage of the current measurement signal with a preset reference voltage Vref, (ii) to set its output to positive (or HIGH) in response to the voltage of the current measurement signal being greater than the reference voltage Vref, and (iii) to set its output to negative (or LOW) in response to the voltage of the current measurement signal being smaller than or equal to the reference voltage Vref. The reference voltage Vref is equal to or approximate to the voltage of the current measurement signal when an insufficient motor current to be describe later is flowing through the electric motor 24.

The controller 23 includes a second latching circuit 58 configured to hold its output (CUR) positive (or HIGH) in response to the output of the comparator CP1 being positive. The second latching circuit 58 is configured to hold its output positive for at least a period of time (for example, 100 milliseconds) equal to or longer than the cycle of the first through sixth PWM signals, each time the output of the comparator CP1 transitions from negative to positive. The control circuit 51 is configured to receive the output of the second latching circuit 58.

The trigger switch 21 intercouples (or interconnects) between (i) the power line Lp and (ii) the first through third switches Q1 through Q3. More specifically, the trigger switch 21 includes (i) a first contact coupled to the power line Lp, and (ii) a second contact coupled to the first through third switches Q1 through Q3, and is configured to establish or cut off coupling (or connection) between the power line Lp and the first through third switches Q1 through Q3.

The controller 23 includes a seventh switch Q7 coupled to (i) the first contact and (ii) the second contact of the trigger switch 21. The seventh switch Q7 is configured (i) to establish coupling (or connection) between the first contact and the second contact of the trigger switch 21 when in its ON-state, and (ii) to cut off the coupling (or the connection) between the first contact and the second contact of the trigger switch 21 when in its OFF-state. Accordingly, the seventh switch Q7 is configured (i) to couple the power line Lp with the first through third switches Q1 through Q3 via the seventh switch Q7 while the trigger switch 21 is in its OFF-state and the seventh switch Q7 is in its ON-state, and (ii) to uncouple the power line Lp from the first through third switches Q1 through Q3 while the trigger switch 21 is in its OFF-state and the seventh switch Q7 is also in its OFF-state. In the present embodiment, the seventh switch Q7 is an n-channel MOSFET. In another embodiment, the seventh switch Q7 may be other types of semiconductor switches including a JFET, a bipolar transistor, an IGBT, and a solid state relay (SSR). In yet another embodiment, the seventh switch Q7 may be a mechanical relay.

The control circuit 51 is configured to output (i) a switch-ON signal for turning ON the seventh switch Q7, and (ii) a switch-OFF signal for turning OFF the seventh switch Q7. In the present embodiment, the switch-ON signal is a positive logic signal, and the switch-OFF signal is a negative logic signal. In another embodiment, the switch-ON signal may be a negative logic signal, and the switch-OFF signal may be a positive logic signal.

The controller 23 includes a second signal cutoff circuit 59 configured to cut off the switch-ON signal output from the control circuit 51. More specifically, the second signal cutoff circuit 59 is configured (i) to be disabled while the output (CUR) of the second latching circuit 58 is positive, and (ii) to be enabled while the output of the second latching circuit 58 is negative. When the second signal cutoff circuit 59 is disabled, the switch-ON signal is delivered to the seventh switch Q7 via the second signal cutoff circuit 59. When the second signal cutoff circuit 59 is enabled, the switch-ON signal is cut off from the seventh switch Q7 by the second signal cutoff circuit 59.

In the present embodiment, the second signal cutoff circuit 59 includes wired logic. More specifically, the second signal cutoff circuit 59 includes a fourth AND gate 59a. The fourth AND gate 59a is configured (i) to deliver the switch-ON signal to the seventh switch Q7 while the output of the second latching circuit 58 is positive, and (ii) to cut off the seventh switch Q7 from the switch-ON signal (or to cut off the switch-ON signal to the seventh switch Q7) by setting an output of the fourth AND gate 59a to negative (or LOW) while the output of the second latching circuit 58 is negative.

The controller 23 includes an electrolytic capacitor C1 configured to deliver a stable motor current to the electric motor 24. The electrolytic capacitor C1 includes (i) an anode coupled to the first contact of the trigger switch 21, and (ii) a cathode coupled to the ground. In another embodiment, the electrolytic capacitor C1 may be removed.

### 2-4. Details of Configuration and Operation of First Latching Circuit

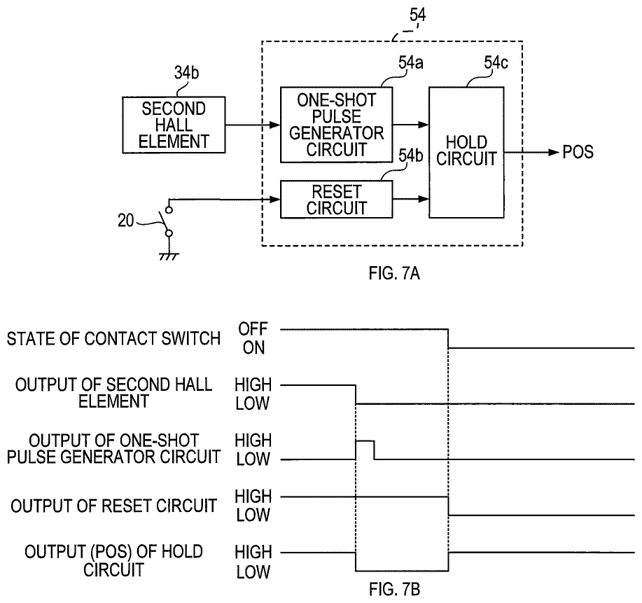

As shown in FIG. 7A, the first latching circuit 54 includes a one-shot pulse generator circuit 54a at its input stage. The one-shot pulse generator circuit 54a is coupled to the second Hall element 34b. As shown in FIG. 7B, the one-shot pulse generator circuit 54a is configured to generate and output a single pulse having a predefined pulse width in response to the output of the second Hall element 34b having transitioned from positive to negative (in other words, in response to a falling edge of the second position detection signal).

As shown in FIG. 7A, the first latching circuit 54 includes a reset circuit 54b at its input stage. The reset circuit 54b is coupled to the contact switch 20. As shown in FIG. 7B, the reset circuit 54b is configured (i) to set its output to positive when the contact switch 20 is in its OFF-state, and (ii) to set its output to negative when the contact switch 20 is in its ON-state.

As shown in FIG. 7A, the first latching circuit 54 includes a hold circuit 54c at its output stage. The hold circuit 54c is coupled to the one-shot pulse generator circuit 54a and the reset circuit 54b. As shown in FIG. 7B, the hold circuit 54c is configured (i) to hold its output (POS) negative at a rising edge (or a positive edge) of a pulse voltage output from the one-shot pulse generator circuit 54a, and (ii) to reset its output to positive in response to the output of the reset circuit 54b having transitioned from positive to negative.

### 2-5. Electrical Operation of Reciprocating Tool

The above-described electrical configuration operates as follows.

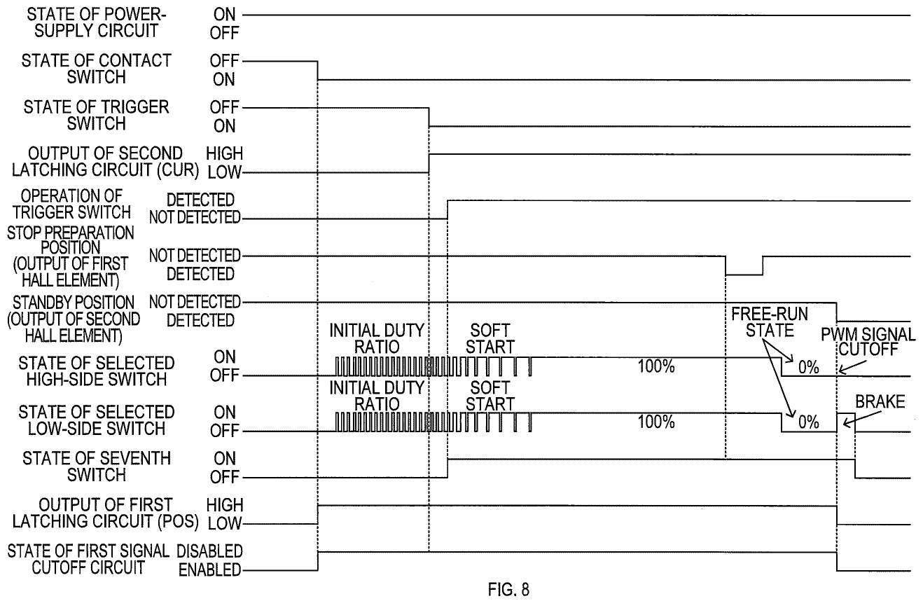

As shown in FIG. 8, when the pressing member 6 is pressed against a workpiece to turn ON the contact switch 20 while the power-supply circuit 52 is in the ON-state, the output (POS) of the first latching circuit 54 is held positive (or HIGH), and the first signal cutoff circuit 56 is disabled. The control circuit 51 detects the rotational position of the rotor 26 based on the first through third pulse signals received from the rotational position detector 24d until this point in time. The control circuit 51 selects (i) one of the high-side switches, and (ii) one of the low-side switches according to a first lookup table stored in the ROM, and outputs the PWM signals corresponding to these selected switches. The first lookup table specifies a combination of the high-side and low-side switches to be selected in association with the rotational position of the rotor 26. The first lookup table is set to select a combination of the high-side and low-side switches that fails the rotor 26 to rotate. More specifically, in the present embodiment, the first lookup table is set to select (i) a combination of the high-side and low-side switches that generates a magnetic field that attracts the first pole 26a of the rotor 26 to the coil (any of the first through third coils 24a through 24c) facing the first pole 26a, or (ii) a combination of the high-side and low-side switches that generates a magnetic field that attracts the second pole 26b of the rotor 26 to the coil (any of the first through third coils 24a through 24c) facing the second pole 26b.

Each of the corresponding PWM signals has an initial duty ratio. The initial duty ratio is greater than zero but insufficient to start the electric motor 24 (for example, 10%). With the initial duty ratio as such, the selected high-side and low-side switches deliver the insufficient motor current to the corresponding one of the first through third coils 24a through 24c. The rotor 26 is configured not to rotate by the insufficient motor current.

When the trigger switch 21 is ON, and the insufficient motor current flows, the output (CUR) of the second latching circuit 58 is held positive (or HIGH), and the second signal cutoff circuit 59 is disabled. When the control circuit 51 detects that the trigger switch 21 is ON based on the output of the second latching circuit 58 being positive, the switch-ON signal is delivered from the control circuit 51 to the seventh switch Q7 to turn ON the seventh switch Q7. Then, the control circuit 51 performs a soft start. In the soft start, the control circuit 51 selects (i) one of the high-side switches and (ii) one of the low-side switches according to a second lookup table stored in the ROM, and outputs the PWM signals corresponding to these selected switches. The second lookup table specifies a combination of the high-side and low-side switches to be selected in association with the rotational position of the rotor 26. The second lookup table is set to select a combination of the high-side and low-side switches that contributes to rotating the rotor 26. The control circuit 51 gradually increases the duty ratio of each of the corresponding PWM signals while performing the soft start.

When the soft start is completed, the control circuit 51 sets the duty ratios of the PWM signals corresponding to the selected high-side and low-side switches to 100%.

When the first Hall element 34a detects that the reciprocating member 18 reaches a stop preparation position, the control circuit 51 starts preparing to stop the electric motor 24. Specifically, the control circuit 51 calculates remaining drive time of the electric motor 24. When the calculated remaining drive time elapses, the control circuit 51 sets the duty ratios of all the first through sixth PWM signals to 0% to bring the electric motor 24 into a free-run state (or coast the electric motor 24).

Next, when the second Hall element 34b detects that the reciprocating member 18 reaches the standby position, (i) the output (POS) of the first latching circuit 54 is reset to negative (or LOW), (ii) the first signal cutoff circuit 56 is enabled, and (iii) the first through third PWM signals are cut off from the first through third switches Q1 through Q3 by the first signal cutoff circuit 56. Almost simultaneously, the control circuit 51 outputs the PWM signals each having a specified duty ratio (for example, 100%) to at least two of the fourth through sixth switches Q4 through Q6 so as to generate dynamic braking (or regenerative braking) in the electric motor 24. As a result, the dynamic braking is generated in the electric motor 24, and the electric motor 24 stops.

When the control circuit 51 detects that the electric motor 24 has stopped based on the first through third pulse signals, the switch-OFF signal is delivered from the control circuit 51 to the seventh switch Q7, and the seventh switch Q7 is turned OFF.

### 2-6. Operation Modes of Reciprocating Tool

As described above, the reciprocating tool 1 is configured to be switched between the single shot mode (or the single firing mode or the sequential firing mode) and the multiple shot mode (or the contact firing mode or the bump firing mode). Operations of the reciprocating tool 1 in the single shot mode and the multiple shot mode are summarized as follows.

In the single shot mode, the reciprocating tool 1 discharges one nail into a workpiece when the trigger 9 is pulled with the pressing member 6 being pressed against the workpiece.

In the single shot mode, the reciprocating tool 1 does not discharge a nail when the pressing member 6 is pressed against a workpiece with the trigger 9 being pulled.

In the multiple shot mode, the reciprocating tool 1 discharges one nail into a workpiece each time the pressing member 6 is pressed against the workpiece with the trigger 9 being pulled.

### 2-7. Processes Executed by Control Circuit

Processes executed by the control circuit 51 (more specifically, the microcomputer 51a) will be described in detail below.

### 2-7-1. Main Routine

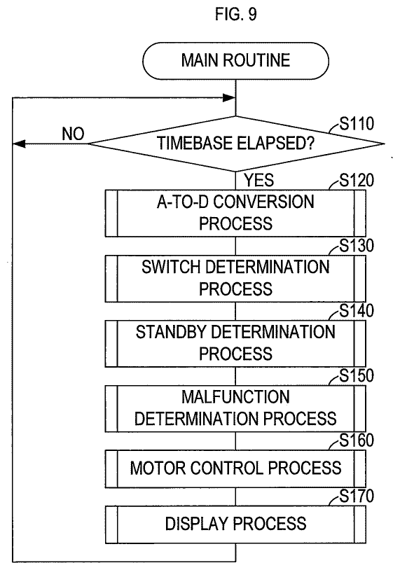

The control circuit 51 repeatedly executes a main routine shown in FIG. 9 during its operation.

As shown in FIG. 9, the control circuit 51 first waits in S110 until a preset timebase elapses (S110: NO). When the timebase elapses (S110: YES), the control circuit 51 proceeds from S120 through S170 sequentially.

In S120, the control circuit 51 executes an A-to-D conversion process. In the A-to-D conversion process, the control circuit 51 converts the battery voltage signal and the current measurement signal into their respective digital values, and stores the digital values in the RAM.

In S130, the control circuit 51 executes a switch determination process. In the switch determination process, the control circuit 51 stores, in the RAM, logic levels of the voltages (i.e., positive or negative, or HIGH or LOW, or 1 or 0) received from the main power switch 36, the mode selection switch 37, the contact switch 20, the first Hall element 34a, the second Hall element 34b, and the second latching circuit 58.

In S140, the control circuit 51 executes a standby determination process. In the standby determination process, the control circuit 51 determines whether to transition the reciprocating tool 1 into a standby state.

In S150, the control circuit 51 executes a malfunction determination process. In the malfunction determination process, the control circuit 51 determines whether an error flag is set. The error flag is (i) set when malfunction has occurred, and (ii) cleared when no malfunction has occurred. When the error flag is set, the control circuit 51 performs a predefined operation that corresponds to the malfunction.

In S160, the control circuit 51 executes a motor control process. The motor control process will be described later in detail.

In S170, the control circuit 51 executes a display process. In the display process, the control circuit 51 turns ON the first indicator 38 or the second indicator 39 in accordance with the set operation mode. More specifically, when the reciprocating tool 1 is set to the single shot mode, the control circuit 51 outputs the first lighting signal to the first indicator 38. When the reciprocating tool 1 is set to the multiple shot mode, the control circuit 51 outputs the second lighting signal to the second indicator 39. In addition, when the error flag is set, the control circuit 51 outputs the first lighting signal and the second lighting signal to the first indicator 38 and the second indicator 39, respectively.

### 2-7-2. Interrupting Process

The control circuit 51, in addition to the above-described main routine, executes a not shown interrupting process. In this interrupting process, the control circuit 51 stores logic levels of the voltages (i.e., positive or negative, or HIGH or LOW, or 1 or 0) of the first through third pulse signals in the RAM. In the present embodiment, the control circuit 51 repeats the interrupting process periodically. In another embodiment, the control circuit 51 may execute the interrupting process in response to the edges or the voltage levels of the first through third pulse signals or other signals.

### 2-7-3. Motor Control Process

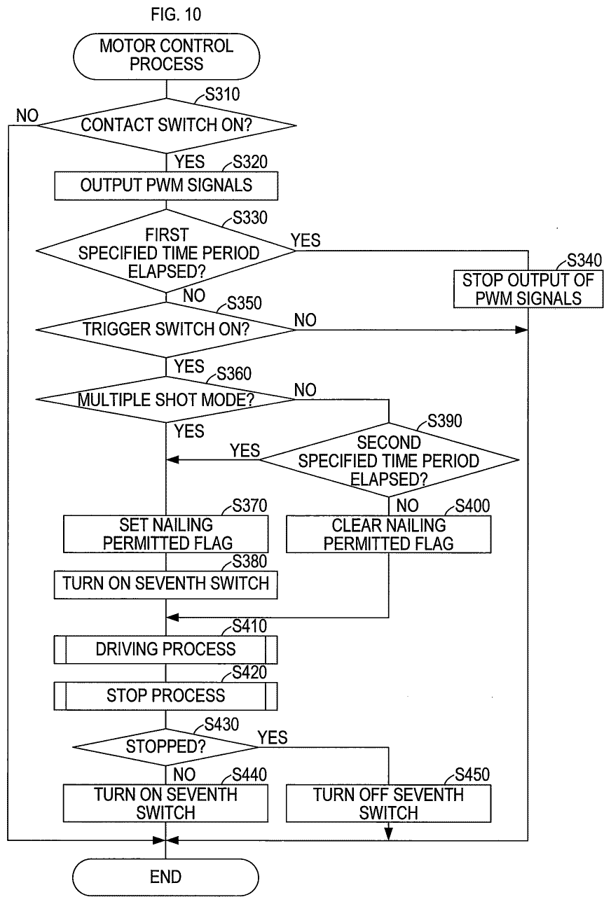

As shown in FIG. 10, in the motor control process, the control circuit 51 first determines whether the contact switch 20 is ON based on the logic level of the voltage of the contact switch 20 stored in the RAM in S310.

When the contact switch 20 is OFF (S310: NO), the control circuit 51 immediately terminates the motor control process. When the contact switch 20 is ON (S310: YES), the control circuit 51 proceeds to S320. In S320, the control circuit 51 outputs the corresponding PWM signals to the selected high-side and low-side switches (in other words, a combination of the high-side and low-side switches that fails the rotor 26 to rotate). Each of the corresponding PWM signals has the above-described initial duty ratio.

In subsequent S330, the control circuit 51 determines whether a first specified time period (for example, 5 seconds) has elapsed since the corresponding PWM signals started to be output. The first specified time period is set to ensure that a nail is not accidentally ejected when the pressing member 6 is held against some object contrary to the user's intention. When the first specified time period has elapsed (S330: YES), the control circuit 51 proceeds to S340 to stop outputting the corresponding PWM signals, and terminates the motor control process.

When the first specified time period has not elapsed (S330: NO), the control circuit 51 proceeds to S350 to determine whether the trigger switch 21 is ON based on the logic level of the output of the second latching circuit 58 stored in the RAM. When the trigger switch 21 is OFF (S350: NO), the control circuit 51 immediately terminates the motor control process.

When the trigger switch 21 is ON (S350: YES), the control circuit 51 proceeds to S360 to determine whether the reciprocating tool 1 is set to the multiple shot mode. More specifically, the control circuit 51 determines whether a multiple shot mode flag is set. The multiple shot mode flag is cleared when the control circuit 51 is activated. In the reciprocating tool 1, each time the user presses the mode selection switch 37, the operation mode of the reciprocating tool 1 is switched between the single shot mode and the multiple shot mode. Accordingly, the control circuit 51 sets or clears the multiple shot mode flag based on the logic level of the voltage of the mode selection switch 37 stored in the RAM.

When the reciprocating tool 1 is set to the multiple shot mode (S360: YES), the control circuit 51 proceeds to S370 to set a nailing permitted flag. The nailing permitted flag indicates that a nail is permitted to be driven. In subsequent S380, the control circuit 51 outputs the switch-ON signal to the seventh switch Q7 to turn ON the seventh switch Q7, and proceeds to S410.

When the reciprocating tool 1 is set to the single shot mode (S360: NO), the control circuit 51 proceeds to S390 to determine whether a second specified time period (for example, 50 milliseconds) has elapsed. The second specified time period is set to ensure that the reciprocating tool 1 does not drive a nail when an operation prohibited for the single shot mode, that is, pressing the pressing member 6 against a workpiece with the trigger 9 being pulled, is performed. When the second specified time period has elapsed (S390: YES), the control circuit 51 proceeds to S370.

When the second specified time period has not elapsed (S390: NO), the control circuit 51 proceeds to S400 to clear the nailing permitted flag.

In subsequent S410, the control circuit 51 executes a driving process.

In the driving process, when the nailing permitted flag is set, the control circuit 51 performs the above-described soft start. When the soft start is completed, the control circuit 51 sets the duty ratios of the PWM signals output to the selected high-side and low-side switches (in other words, the high-side and low-side switches that contribute to rotating the rotor 26) to 100%.

When the nailing permitted flag is cleared, the control circuit 51 immediately terminates the driving process.

In subsequent S420, the control circuit 51 executes a stop process.

In the stop process, the control circuit 51 clears a motor stopped flag. The motor stopped flag indicates that the electric motor 24 is stopped. Then, the control circuit 51 determines whether the reciprocating member 18 is in the stop preparation position based on the logic level of the voltage of the first Hall element 34a stored in the RAM. When the reciprocating member 18 is in the stop preparation position, the control circuit 51 calculates the remaining drive time of the electric motor 24. When the calculated remaining drive time elapses, the control circuit 51 sets the duty ratios of all the first through sixth PWM signals to 0%, and brings the electric motor 24 into the free-run state.

Then, the control circuit 51 determines whether the reciprocating member 18 is in the standby position based on the logic level of the voltage of the second Hall element 34b stored in the RAM. When the reciprocating member 18 is in the standby position, the control circuit 51 outputs the PWM signals each having the specified duty ratio (for example, 100%) to at least two of the fourth through sixth switches Q4 through Q6 so as to generate the dynamic braking in the electric motor 24.

Then, the control circuit 51 determines whether the electric motor 24 is stopped based on the logic levels of the voltages of the first through third pulse signals stored in the RAM until this point in time. When the electric motor 24 is stopped, the control circuit 51 sets the motor stopped flag.

When the stop process as above is completed, the control circuit 51 proceeds to S430 to determine whether the electric motor 24 is stopped. More specifically, the control circuit 51 determines whether the motor stopped flag is set.

When the electric motor 24 is not stopped (in other words, the motor stopped flag is cleared) (S430: NO), the control circuit 51 proceeds to S440. In S440, the control circuit 51 outputs the switch-ON signal to the seventh switch Q7 to turn ON the seventh switch Q7. In other words, the control circuit 51 continues to output the switch-ON signal to the seventh switch Q7, and holds the seventh switch Q7 in its ON-state.

When the electric motor 24 is stopped (in other words, the motor stopped flag is set) (S430: YES), the control circuit 51 proceeds to S450. In S450, the control circuit 51 outputs the switch-OFF signal to the seventh switch Q7 to turn OFF the seventh switch Q7.

### 2-8. Technical Effects in Embodiment

In the reciprocating tool 1 configured as above, when the reciprocating member 18 reaches the standby position in its one reciprocating motion, the first through third AND gates 56a through 56c of the first signal cutoff circuit 56 cut off the drive circuit 55 from the first through third PWM signals without delay. Consequently, driving of the electric motor 24 by the drive circuit 55 can be immediately stopped.

Accordingly, in the reciprocating tool 1, it is possible to inhibit delay in stopping operation of the electric motor 24.

Also, in the reciprocating tool 1, when the reciprocating member 18 reaches the standby position in its one reciprocating motion, the fourth through sixth PWM signals to brake the electric motor 24 are output from the control circuit 51 to the drive circuit 55. Consequently, the electric motor 24 can be immediately stopped.

Also, in the reciprocating tool 1, the user can disable the first signal cutoff circuit 56 and drive the electric motor 24 by pressing the pressing member 6 against a workpiece.

Also, the reciprocating tool 1 is configured to detect the position of the reciprocating member 18 using a magnetic field. Thus, the reciprocating tool 1 has great durability, compared with if the reciprocating tool 1 were configured to mechanically detect the position of the reciprocating member 18. Furthermore, the reciprocating tool 1 as such is not susceptible to dust in position detection of the reciprocating member 18, compared with if the reciprocating tool 1 were configured to optically detect the position of the reciprocating member 18.

Also, in the reciprocating tool 1, since the first Hall element 34a and the second Hall element 34b are disposed outward from the holder 31 in the radial direction of the holder 31, the size of the reciprocating tool 1 in a direction intersecting the radial direction of the holder 31 can be reduced.

Also, in the reciprocating tool 1, since the holder 31 is a non-magnetic member, it can be easier for the first Hall element 34a or the second Hall element 34b to detect the south pole of the first magnet 32 or the north pole of the second magnet 33.

### 2-9. Correspondence Between Terms

In the present embodiment, the top dead center of the reciprocating member 18 corresponds to an example of the first dead center in Overview of Embodiments, and the bottom dead center of the reciprocating member 18 corresponds to an example of the second dead center in Overview of Embodiments. Each of the first through third PWM signals corresponds to an example of the at least one drive signal in Overview of Embodiments, a combination of the second magnet 33 and the second Hall element 34b corresponds to an example of the position detector in Overview of Embodiments, and the second position detection signal corresponds to an example of the position detection signal in Overview of Embodiments. The north pole of the second magnet 33 corresponds to an example of the first magnetic pole in Overview of Embodiments, and the south pole of the second magnet 33 corresponds to an example of the second magnetic pole in Overview of Embodiments. The first signal cutoff circuit 56 corresponds to an example of the signal cutoff circuit in Overview of Embodiments, and a combination of the first through third AND gates 56a through 56c corresponds to an example of the wired logic in Overview of Embodiments. The contact switch 20 corresponds to an example of the manual switch in Overview of Embodiments, and the first latching circuit 54 corresponds to an example of the latching circuit in Overview of Embodiments.

### 2-10. Variations

The present disclosure is not limited to the above-described embodiment, and can be practiced in various manners.

### 2-10-1. First Variation

The reciprocating tool 1 of the first variation corresponds to the reciprocating tool 1 of the above-described embodiment but is partially modified.

Accordingly, components that are the same as those in the above-described embodiment are given the same reference numerals and their explanations are omitted. Differences from the above-described embodiment will be explained hereinafter.

### 2-10-1-1. Differences in Mechanical Structure

First, in the reciprocating tool 1 of the first variation, the holder 31, the first magnet 32, the second magnet 33, the Hall effect IC 34, and the first latching circuit 54 in the above-described embodiment are eliminated.

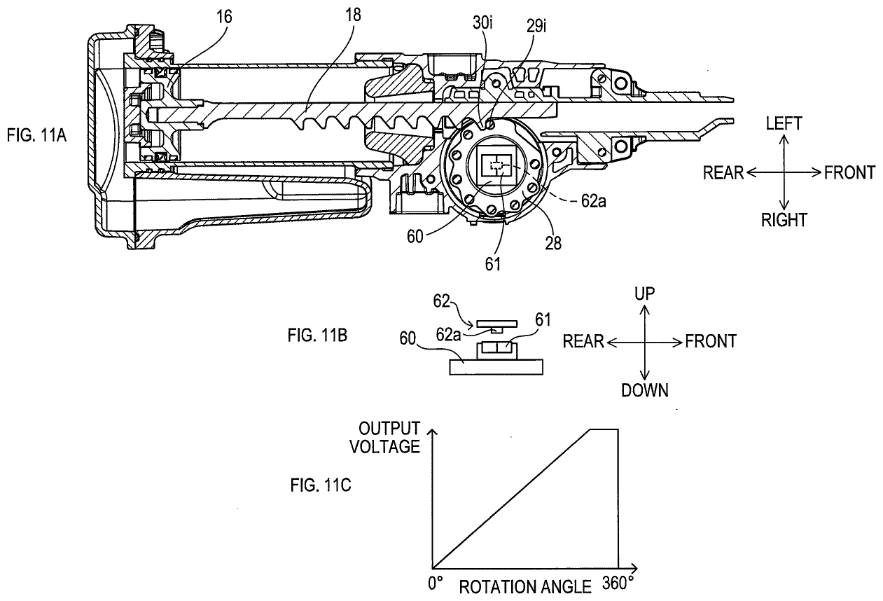

As shown in FIGS. 11A and 11B, the reciprocating tool 1 in the first variation includes an alternative holder 60 in a center of the cam 28 (in other words, a center of rotation of the cam 28).

The alternative holder 60 is a non-magnetic member. The alternative holder 60 is configured to rotate together with the cam 28. The alternative holder 60 includes a third magnet 61 on its top surface. The third magnet 61 is disposed in a center of the alternative holder 60, and thus in the center of the cam 28. In other words, the third magnet 61 is disposed on the top surface of the alternative holder 60 such that its north pole and south pole face outward in a radial direction of the alternative holder 60.

The reciprocating tool 1 of the first variation includes an alternative Hall effect IC 62 above the third magnet 61. The alternative Hall effect IC 62 includes a third Hall element 62a.

As shown in FIG. 11C, the third Hall element 62a is configured such that its output voltage continuously increases as a rotation angle of the third magnet 61 (and thus, a rotation angle of the cam 28) increases. In the first variation, the third Hall element 62a is configured (i) to output a voltage of zero volts when the third magnet 61 is at the rotation angle of zero degrees (or 360 degrees), and (ii) to output its maximum voltage when the third magnet 61 is at the rotation angle immediately before 360 degrees. In the first variation, the third magnet 61 is disposed on the alternative holder 60 such that (i) the top dead center of the reciprocating member 18 corresponds to the rotation angle of zero degrees, and (ii) the standby position of the reciprocating member 18 corresponds to the rotation angle immediately before 360 degrees.

### 2-10-1-2. Differences in Electrical Configuration

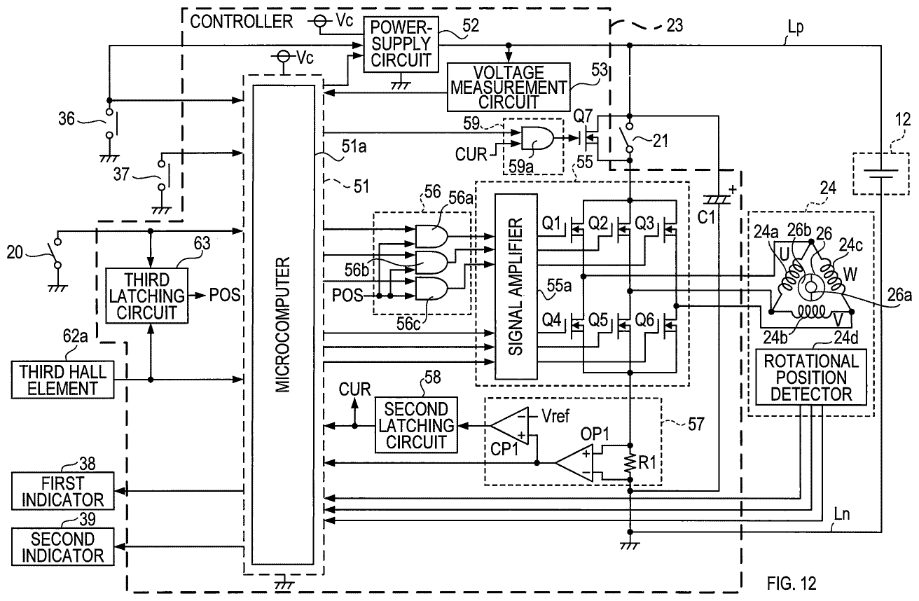

As shown in FIG. 12, the reciprocating tool 1 of the first variation includes a third latching circuit 63 in place of the first latching circuit 54 in the above-described embodiment. The third latching circuit 63 is coupled to (i) the third Hall element 62a and (ii) the contact switch 20. The third Hall element 62a is also coupled to the control circuit 51.

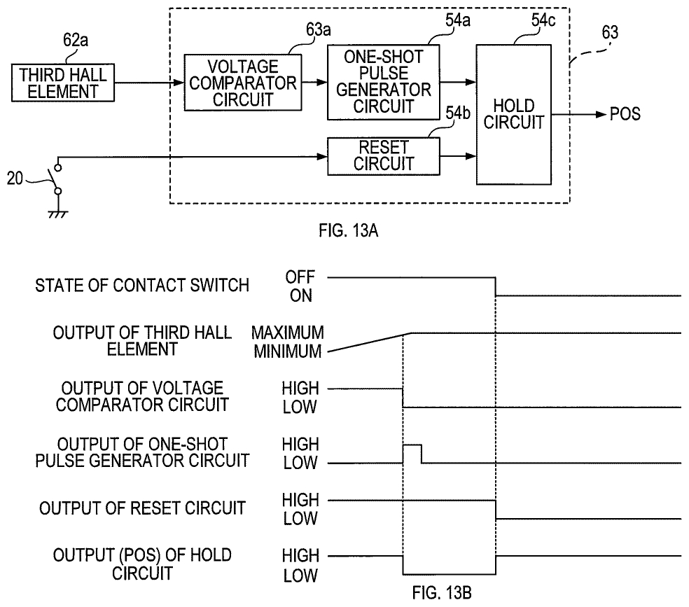

As shown in FIG. 13A, the third latching circuit 63 differs from the first latching circuit 54 in that the third latching circuit 63 includes a voltage comparator circuit 63a at its input stage, in addition to the one-shot pulse generator circuit 54a, the reset circuit 54b, and the hold circuit 54c in the above-described embodiment.

The voltage comparator circuit 63a is coupled to the third Hall element 62a. The voltage comparator circuit 63a is configured to compare the output voltage of the third Hall element 62a with a specified voltage. In the first variation, this specified voltage is set to be equivalent to the output voltage of the third Hall element 62a when the reciprocating member 18 reaches the standby position.

As shown in FIG. 13B, the voltage comparator circuit 63a is configured (i) to set its output to positive (or HIGH) until the output voltage of the third Hall element 62a reaches the specified voltage, and (ii) to set its output to negative (or LOW) when the output voltage of the third Hall element 62a reaches the specified voltage.

In the first variation, the one-shot pulse generator circuit 54a generates and outputs a single pulse in response to the output of the voltage comparator circuit 63a having transitioned from positive to negative (in other words, in response to a falling edge of the output of the voltage comparator circuit 63a).

### 2-10-1-3. Differences in Process

In the main routine of the first variation, the control circuit 51 is configured to convert the output voltage of the third Hall element 62a into a digital value and store the digital value in the RAM in the A-to-D conversion process of S120. In the switch determination process of S130, the control circuit 51 does not store the logic levels of the voltages of the first Hall element 34a and the second Hall element 34b in the RAM.

In the motor control process of the first variation, the control circuit 51 determines whether the reciprocating member 18 is in the stop preparation position or in the standby position, based on the digital value of the output voltage of the third Hall element 62a stored in the RAM, in the stop process of S420.

### 2-10-1-4. Technical Effects in First Variation

The reciprocating tool 1 of the first variation configured as above can exhibit the same effects as those of the reciprocating tool 1 of the above-described embodiment.

### 2-10-2. Other Variations

In one variation, the first signal cutoff circuit 56, the second signal cutoff circuit 59, the first latching circuit 54, the second latching circuit 58, and/or the third latching circuit 63 may include a PLD (such as a FPGA).

In one variation, the standby position of the reciprocating member 18 may differ from the position to stop the reciprocating member 18.

### 2-11. Supplementary Explanation

Two or more functions achieved by one element of the above-described embodiment may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiment may be omitted. At least a part of the configurations in the above-described embodiment may be added to or replaced with another part of the configurations in the above-described embodiment.

What is claimed is:

1. A reciprocating tool comprising:
a reciprocating member configured to reciprocate between first dead center and second dead center;
an electric motor configured to generate a driving force;
a transmission device configured to transmit the driving force of the electric motor to the reciprocating member at least in a stroke of the reciprocating member from the second dead center to the first dead center;
a control circuit configured to output at least one drive signal for driving the electric motor;
a drive circuit configured (i) to receive the at least one drive signal, and (ii) to drive the electric motor in accordance with the at least one drive signal received;
a position detector configured to output a position detection signal each time the reciprocating member reaches a specified position in at least one reciprocating motion thereof; and
a signal cutoff circuit including wired logic configured to cut off the drive circuit from the at least one drive signal in response to the position detector outputting or having output the position detection signal.

2. The reciprocating tool according to claim 1, wherein:
the signal cutoff circuit is configured (i) to be disabled upon receipt of a first logic value, and (ii) to be enabled upon receipt of a second logic value; and
the second logic value is opposite to the first logic value.

3. The reciprocating tool according to claim 2, further comprising:
a manual switch configured to be manually operated by a user of the reciprocating tool; and
a latching circuit configured to continue to output the second logic value to the signal cutoff circuit until the manual switch is manually operated in response to the position detector outputting or having output the position detection signal.

4. The reciprocating tool according to claim 3, further comprising:
a pressing member configured to be pressed against a workpiece by the user,
wherein the manual switch is configured to be manually operated by the pressing member being pressed against the workpiece.

5. The reciprocating tool according to claim 1,
wherein the position detector includes (i) a magnet having a first magnetic pole and a second magnetic pole and (ii) a Hall element configured to detect the first magnetic pole of the magnet, and is configured such that the Hall element detects the first magnetic pole and outputs the position detection signal in response to the reciprocating member having reached the specified position.

6. The reciprocating tool according to claim 5, wherein:
the transmission device includes:
a cam (i) including an outer circumference having two or more pins aligned in a circumferential direction of the cam, and (ii) configured to rotate by the driving force of the electric motor; and
a holder (i) holding the magnet, and (ii) configured to rotate with the cam; and
the reciprocating member (i) extends between the first dead center and the second dead center, (ii) includes two or more racks in its extending direction, and (iii) is configured to be driven from the second dead center to the first dead center by each of the two or more racks engaging with a corresponding one of the two or more pins.

7. The reciprocating tool according to claim 6,
wherein the first magnetic pole faces outward in a radial direction of the holder.

8. The reciprocating tool according to claim 6,
wherein the cam and the holder are configured to rotate around a common axis.

9. The reciprocating tool according to claim 8,
wherein the electric motor includes a rotor serving as the common axis.

10. The reciprocating tool according to claim 6,
wherein the holder is a non-magnetic member.

11. The reciprocating tool according to claim 1,
wherein the at least one drive signal is at least one pulse-width modulated signal.

12. The reciprocating tool according to claim 11, wherein:
the electric motor is a brushless DC motor including first through third coils;
the drive circuit includes first through sixth semiconductor switches that (i) form at least a part of a full-bridge circuit and (ii) are coupled to the first through third coils;
the first through third semiconductor switches are high-side switches in the full-bridge circuit;
the fourth through sixth semiconductor switches are low-side switches in the full-bridge circuit;
the at least one pulse-width modulated signal includes first through third pulse-width modulated signals respectively corresponding to the first through third semiconductor switches; and
the wired logic is configured to cut off the drive circuit from the first through third pulse-width modulated signals in response to the position detector outputting or having output the position detection signal.

13. The reciprocating tool according to claim 12, wherein:
the control circuit is configured to output, to the drive circuit, fourth through sixth pulse-width modulated signals to brake the electric motor in response to the position detector outputting or having output the position detection signal; and
the fourth through sixth pulse-width modulated signals respectively correspond to the fourth through sixth semiconductor switches.

14. The reciprocating tool according to claim 13,
wherein the control circuit includes a microcomputer configured to output the first through sixth pulse-width modulated signals.

15. The reciprocating tool according to claim 1,
wherein the specified position corresponds to (i) a stop position to stop the reciprocating member, and/or (ii) a standby position where the reciprocating member waits for at least one next reciprocating motion of the reciprocating member.

16. The reciprocating tool according to claim 1, further comprising:
a cylinder containing compressed gas therein; and
a piston that (i) is inside the cylinder, and (ii) urges the reciprocating member toward the second dead center by the compressed gas, wherein
the reciprocating member is configured to be driven from the first dead center to the second dead center by the piston.

17. The reciprocating tool according to claim 16,
wherein the reciprocating member is configured (i) to be positioned at the first dead center in response to the piston being positioned at its top dead center, and (ii) to be positioned at the second dead center in response to the piston being positioned at its bottom dead center.

18. A method for controlling an electric motor of a reciprocating tool, the method comprising:
outputting, to a drive circuit of the reciprocating tool, at least one drive signal for driving the electric motor, the drive circuit being configured to drive the electric motor in accordance with the at least one drive signal;
transmitting a driving force of the electric motor to a reciprocating member of the reciprocating tool, the reciprocating member being configured to reciprocate between first dead center and second dead center, the driving force being transmitted at least from the second dead center to the first dead center; and
stopping driving of the electric motor by wired logic, the wired logic being configured to cut off the drive circuit from the at least one drive signal in response to the reciprocating member having reached a specified position in at least one reciprocating motion thereof.
